(19) United States
(12) Patent Application Publication
(10) Pub. No.: US 2009/0154699 A1
(43) Pub. Date: Jun. 18, 2009

(54) NETWORK-BASED DATA EXCHANGE

(75) Inventors: Alex TSERKOVNY, Brookline, MA (US); Antoinette F. Hershey, Acton, MA (US); Thomas J. Antell, Westford, MA (US)

Correspondence Address: VERIZON;PATENT MANAGEMENT GROUP, 1320 North Court House Road, 9th Floor, ARLINGTON, VA, 22201-2909, US

(73) Assignee: Verizon Services Organization Inc., Irving, TX (US)

(21) Appl. No.: 11/955,912

(22) Filed: Dec. 13, 2007

(51) Int. Cl. G06F 15/167; H04K 1/00; G06Q 40/00

(52) U.S. Cl. 380/255; 709/213; 705/7; 705/1; 705/34

(57) ABSTRACT

A method associated with the exchange of information over a network may include receiving a request for information from a first entity, identifying a second entity based on the request and receiving information from the first entity defining data or a type of data to be provided by the second entity. The method may also include modifying the request to a format compatible with the second entity and forwarding the modified request to the second entity. The method may further include receiving data from the second entity in response to the modified request, modifying the data from the second entity and forwarding the modified data to the first entity.

### BACKGROUND INFORMATION

Exchanging information over networks has become increasingly common. For example, businesses often exchange information over the Internet with customers, suppliers and other entities. Ensuring that an entity receiving a communication, such as a request for information, is able to understand the communication, as well as ensuring that the party requesting the information is authorized to receive the requested information is very important to both the entity originating the communication and the entity receiving the communication. In addition, ensuring that these communications are secure and reliable is very important to both entities.

### BRIEF DESCRIPTION OF THE DRAWINGS

FIG. 1 schematically illustrates an exemplary architecture in which systems and methods described herein may be implemented;

FIG. 2 illustrates an exemplary network in which systems and methods described herein may be implemented;

FIG. 3 illustrates an exemplary configuration of components of the data exchange broker of FIG. 2;

FIG. 4 illustrates exemplary processing associated with establishing a data exchange service;

FIG. 5 illustrates an exemplary data exchange model; and

FIGS. 6 and 7 illustrate exemplary processing by various devices illustrated in FIG. 2.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention. Instead, the scope of the invention is defined by the appended claims and their equivalents.

Implementations described herein relate to an endpoint data exchange infrastructure and service that allows various entities to efficiently and securely exchange information. An intermediate device in the data exchange infrastructure facilitates transactions and the exchange of information in a reliable, secure and accountable manner. The infrastructure may also allow various entities that use different systems that execute different networking protocols/standards to exchange data without requiring the entities to make significant changes to their systems or equipment.

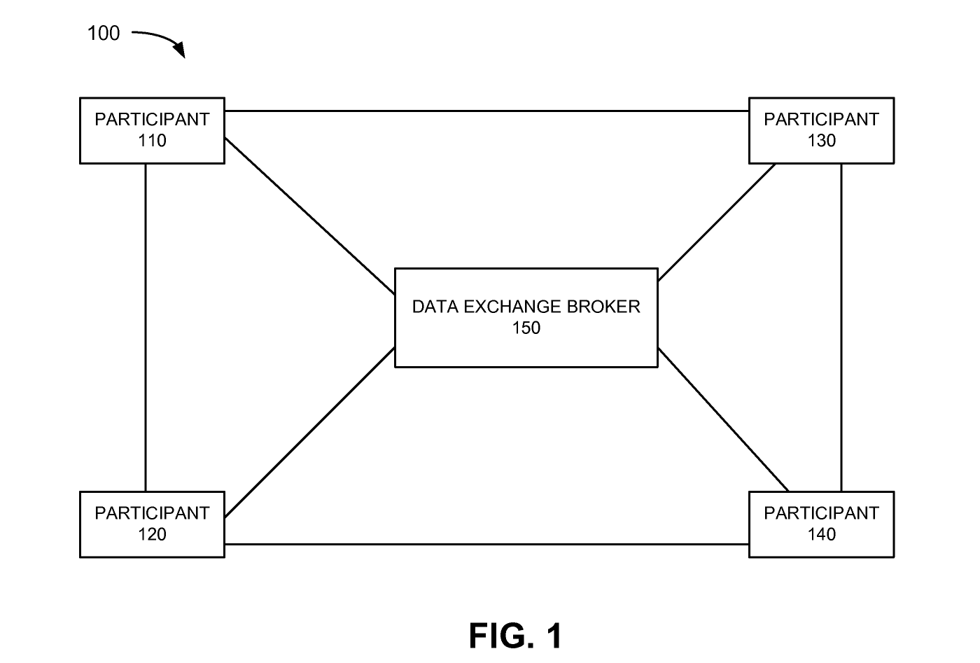

FIG. 1 is a block diagram schematically illustrating an exemplary system architecture/system 100 in which methods and systems described herein may be implemented. Referring to FIG. 1, system 100 includes participants 110, 120, 130 and 140 and data exchange broker 150. The exemplary configuration illustrated in FIG. 1 is provided for simplicity. It should be understood that a typical system may include more or fewer devices than illustrated in FIG. 1.

Participants 110-140 may represent providers, consumers and other clients/entities that wish to exchange information, provide services, receive services, etc. Each of participants 110-140 may include a device, such as a workstation, a personal computer (PC), a laptop computer, a personal digital assistant (PDA), a web-based appliance, a wireless telephone or another type of computation or communication device, or a process running on one of these devices. Participants 110-140 may communicate with data exchange broker 150 and other ones of participants over a network (not shown) via wired, wireless or optical connections.

Data Exchange Broker (DEB) 150 may include a server/computing device, or a set of servers/computing devices. In general, DEB 150, also referred to herein as a platform or a data exchange platform, may provide and manage access rights and privileges associated with data exchange endpoint entities (e.g., participants 110-140) to allow participants 110-140 to communicate with each other, exchange information, etc., on a managed peer-to-peer basis. For example, in one implementation, DEB 150 may match information regarding a data exchange endpoint entity to account information and identify business policies and/or regulatory requirements governing what services the particular endpoint entity is entitled to use and/or access, as described in more detail below.

DEB 150 may also enable participants 110-140 to negotiate a business arrangement that includes communications-related arrangements for transmitting and receiving information. For example, DEB 150 may determine the type of information that may be sent between participants 110-140, identify a selected one of participants 110-140 with whom another one of participants 110-140 may communicate, define a quantity of information that may be provided in a transaction between ones of participants 110-140, etc.

In an exemplary implementation, once each of the various participants 110-140 have registered with DEB 150 and indicated, for example, the type of information that will be involved in their particular transactions, DEB 150 may provision for the particular services to ensure that participants 110-140 can, for example, communicate with each other in a seamless and secure manner even when ones of participants 110-140 have systems that operate in accordance with different standards/protocols than other ones of participants 110-140. That is, DEB 150 may provide for inter-operability between participants 110-140 and also provide security-related processing and other processing for facilitating communications between participants 110-140.

Participants 110-140 may forward information to DEB 150 via proxies (not shown in FIG. 1). For example, proxies may provide various security services, such as encryption and decryption of message data. The proxies may also forward control and/or management information to DEB 150 for communications involving participants 110-140. This control/management information may be service management information (SMI) that may include, for example, information regarding the size of messages, time stamp information and other identification information that may be used to trace back, if necessary, the history of each transaction in system 100. The SMI may be used, for example, for non-repudiation purposes to later prove that a message/information has been sent and received by the appropriate parties. DEB 150 may also authenticate clients 110-140, encrypt messages, sign messages and compress messages prior to routing messages to the appropriate destination (e.g., a target service uniform resource locator (URL)). DEB 150 may also use the received SMI for billing, auditing, network monitoring, statistical analysis or other purposes associated with facilitating or analyzing transactions involving participants 110-140, as described in detail below. As one example, DEB 150 may gather metering information, such as the amount of data transmitted, response times of participants 110-140, etc., to provide for accurate billing for participants 110-140 based on the particular services provided and to ensure, for example, that the communications satisfied various quality of service (QoS)-related requirements, service level agreements (SLAs), etc.

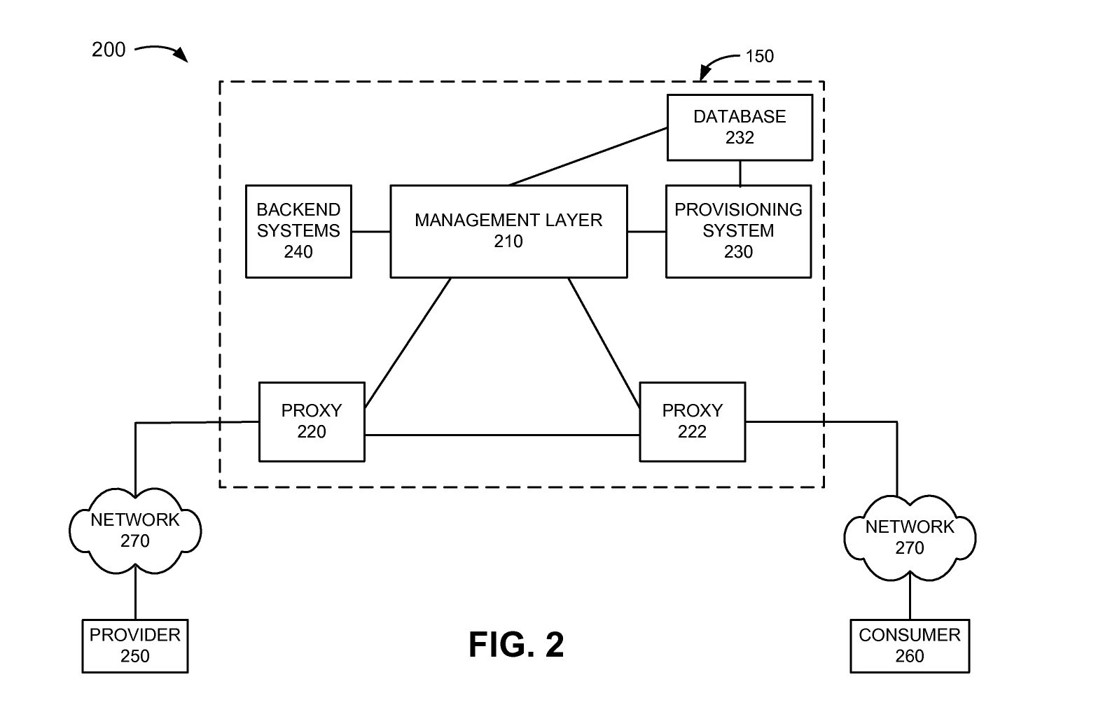

FIG. 2 illustrates a configuration of an exemplary network 200 in which methods and systems described herein may be implemented. Referring to FIG. 2, network 200 includes DEB 150 (illustrated within the dotted box), provider 250, consumer 260 and network 270. DEB 150 may include management layer 210, proxy 220, proxy 222, provisioning system 230, database 232 and backend systems 240. The configuration associated with network 200 in FIG. 2 is provided for simplicity. It should be understood that additional components and/or different components may be included in network 200. For example, various routers, switches, gateways (not shown) may be included in network 200 for routing purposes. In addition, DEB 150 may include additional devices, such as additional proxies for routing data to and from subscribers of the services of DEB 150.

DEB 150 may enroll or register provider 250 as a network-based data exchange infrastructure customer, define the digital data that provider 250 will exchange/provide to other entities, publish information about the digital data within the context of a service level agreement (SLA), etc. Each SLA may be based on the selection of digital data validation schemes, specific digital data exchange security levels and digital data transformation options. DEB 150 may also enroll or register consumer 260 as a network-based data exchange infrastructure customer and select particular digital data to exchange with various providers. Because DEB 150 acts as a broker between consumer and provider endpoints (e.g., consumer 260 and provider 250, respectively), DEB 150 may maintain strict associations between these endpoints and the particular digital data to be exchanged. These associations ensure both the availability of the digital data and the authorized access to that data.

In an exemplary implementation, provider 250 may represent a provider of information, services (e.g., web-related services), etc. Consumer 260 may represent a consumer of information, services, etc., provided by provider 250. DEB 150 may facilitate transactions (e.g., the exchange of information) between provider 250 and consumer 260 such that provider 250 and consumer 260 have little to no processing burden associated with the transaction, other than to provide the previously agreed upon information, service, etc., as described in detail below.

DEB 150 may also provide delivery related functions and system related functions associated with managing data exchange in network 200. The delivery related functions may include, for example, security related processing, message validation, transport and routing of messages, ensuring quality of service (QoS), non-repudiation services, providing and/or facilitating service level agreements (SLAs), ensuring that communication sessions meet QoS requirements and SLAs, transformation and mapping of different protocols for compatibility and compliance with various standards and protocols and other delivery related functions. The system related functions may include, for example, monitoring, auditing, provisioning, accounting and billing, performance management, statistical analysis, load balancing, fail over or fail safe processing and other system related functions. The particular delivery and security related functions may be divided among components in DEB 150, as described in more detail below.

Management layer 210 may perform various functions associated with managing the operations of DEB 150. For example, management layer 210 may maintain information associated with subscribers of the services of DEB 150. Management layer 210 may use this information to make policy decisions governing business transactions. This information may include provisioning information about subscribers, along with electronic business policies that control the exchange of business data in a secure, accountable and highly trusted manner. Management layer 210 may also monitor all business transactions and provide control processing and data retrieval necessary to broker services between customers/subscribers. In exemplary implementations, management layer 210 may provide any particular services to subscribers to facilitate transactions between the subscribers, based on the particular subscribers and their requirements.

Management layer 210 may also provide and guarantee secure and highly accountable data exchanges between providers and consumers, such as provider 250 and consumer 260. For example, management layer 210 may enforce business data exchange policies and monitor business transactions between provider 250 and consumer 260. Management layer 210 may, for example, receive message control directives from a proxy (e.g., one of proxies 220 or 222) and send access entitlements, endpoint address information (e.g., URLs) and transformation schemas to another proxy. In addition, management layer 210 may also receive the delivery status of a transaction, security alerts and process statistics from the proxies 220 and 222. In an exemplary implementation, the centralized management layer 210 and the distributed proxies (e.g., proxies 220 and 222) may use, for example, simple object access protocol (SOAP) messages to communicate with each other.

Proxies 220 and 222 may allow participants who conduct business transactions with other parties to exchange data in a secure, accountable and highly trusted manner. Proxies 220 and 222 may act as interfaces or gateways to those business information systems that, for example, use or host various service. For example, proxies 220 and 222 may interact with management layer 210 to perform address resolution and may forward/receive information associated with transactions between enterprise customers. Proxies 220 and 222 may also provide various security related functions. For example, proxies 220 and 222 may provide message validation and extensible markup language (XML) encryption. Proxies 220 and 222 may also perform XML parsing, message transformations (e.g., extensible stylesheet language (XSL) transformations) and message compression via, for example, strict adherence to web services standards or adherence to agreed upon parameters. Proxies 220 and 222 may also gather management data, such as response times and metering information. Proxies 220 and 222 may also queue messages locally, thereby ensuring efficient exchange of data. Proxies 220 and 222 may further interact with management layer 210 to perform dynamic routing to other proxies in network 200. The dynamic routing may be used for load balancing the handling of messages among a number of proxies in network 200, to avoid proxies that may be undergoing maintenance or are experiencing problems (e.g., as a fail safe or fail over mechanism), or for other reasons.

In an exemplary implementation, each of the proxies in network 200 (e.g., proxies 220 and 222 and other proxies that are not shown) may forward transaction information associated with a data exchange or communication session between two customers (e.g., provider 250 and consumer 260) to management layer 210 each time that the proxy receives a communication in network 200. This transaction information may be stored and used by other devices/systems in network 200, such as backend systems 240, as described in detail below.

Provisioning system 230 may include provisioning information used by management layer 210 to ensure that customers are able to communicate in a seamless, transparent manner in accordance with agreed to protocols, standards, etc. For example, provisioning system 230 may allow subscribers, such as provider 250 and consumer 260, to communicate in accordance with SLAs regarding the exchange of information between these entities. These SLAs may include agreed upon security measures required for communications between these entities. Database 232 may include various data, such as subscriber data associated with subscribers of various services in network 200. Management layer 210 may store and/or use this information when registering subscribers, setting up a service between subscribers in network 200, identifying parameters associated with communications between subscribers, etc.

Backend systems 240 may receive usage information from management layer 210 and use this information for various purposes. For example, backend systems 240 may include a billing system, an auditing system, a network monitoring system, a statistical analysis system and other systems associated with billing, auditing, monitoring, analyzing, etc., transactions involving subscribers (e.g., subscribers in network 200, such as provider 250 and consumer 260). As an example, a billing system included in backend systems 240 may generate billing information for subscribers. As another example, an auditing system included in backend systems 240 may audit transactions involving subscribers. As still another example, a monitoring system included in backend systems 240 may monitor transactions for QoS purposes, to ensure that the transactions meet a previously agreed upon SLA, etc.

Provider 250 and consumer 260 may correspond to two of participants 110-140 illustrated in FIG. 1. In an exemplary implementation, provider 250 may be a data exchange endpoint entity that hosts various elements related to business functions and generates and/or provides digital data for exchange. Consumer 260 may be a data exchange endpoint entity that receives digital data from provider 250 via proxies 220 and 222 and uses the particular digital data of a provider to satisfy specific business needs.

Network 270 may include one or more networks, such as a local area network (LAN), a wide area network (WAN), a metropolitan area network (MAN), a telephone network, such as the Public Switched Telephone Network (PSTN), the Internet, a cellular network, a satellite network, another type of network that is capable of transmitting data from a source device to a destination device or a combination of networks. Network 270 may also include one or more wireless networks for receiving wireless signals and forwarding the wireless signals toward the intended destination.

Firewalls located at provider 250 and/or consumer 260 (not shown) may also be included in network 200 to provide additional protection to provider 250 and consumer 260, respectively. For example, firewalls may be coupled to provider 250 and consumer 260 to filter data and/or block data that may be associated with a network attack having malicious purposes. DEB 150, however, may operate outside the subscriber's (e.g., provider 250 and/or consumer 260) firewall.

In an exemplary implementation, management layer 210, provisioning system 230, database 232 and backend systems 240 may be located in the same server/computing device and proxies 220 and 222 may be distributed throughout network 200. In other implementations, provisioning system 230, database 232 and backend systems 240 may be implemented in a separate device/system than management layer 210. In still other implementations, proxies 220 and 222 may be co-located with management layer 210. In still further implementations, the functions described herein as being performed by one or more devices in network 200 may alternatively be performed by another device. For example, in some implementations, no proxies may be included in network 200 and the functions described as being performed by the proxies may be performed by other devices, such as management layer 210. In other words, components of DEB 150 may be centralized, distributed or a combination of centralized and distributed within network 200 based on the particular implementation.

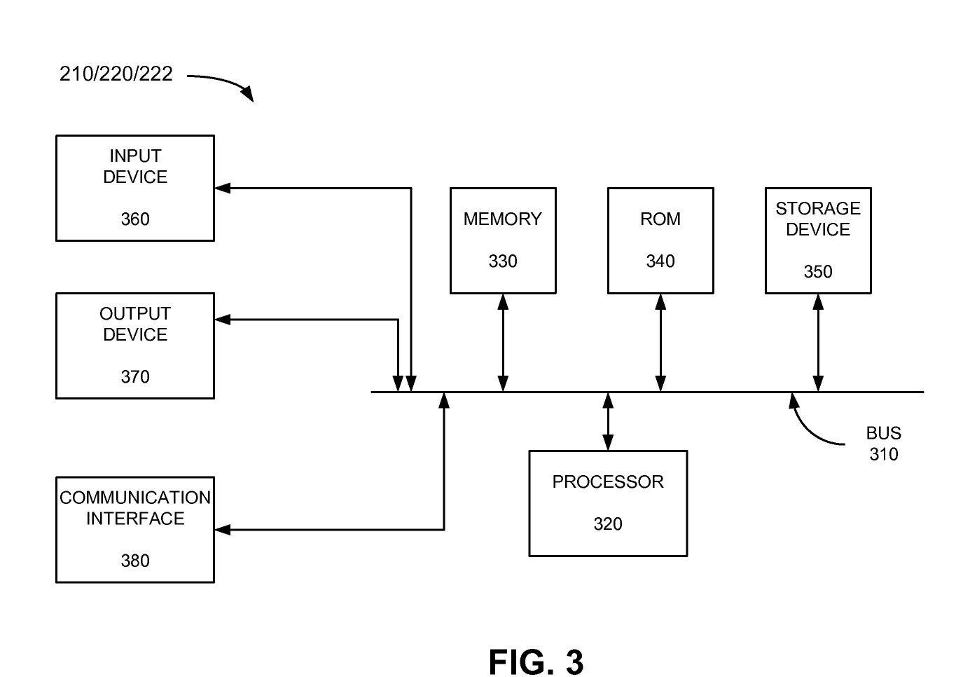

FIG. 3 illustrates an exemplary configuration of a device/system in which management layer 210 may be implemented. Proxies 220 and 222, provisioning system 230 and backend systems 240 may each be configured in a similar manner.

Referring to FIG. 3, management layer 210 may include bus 310, processor 320, main memory 330, read only memory (ROM) 340, storage device 350, input device 360, output device 370, and communication interface 380. Bus 310 may include a path that permits communication among the elements of management layer 210.

Processor 320 may include a processor, microprocessor, or processing logic that may interpret and execute instructions. Memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive.

Input device 360 may include a mechanism that permits an operator to input information to management layer 210 (or proxies 220 or 222), such as a keyboard, a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that management layer 210 use to communicate with other devices and/or systems. For example, communication interface 380 may include a modem or an Ethernet interface to a LAN. Alternatively, communication interface 380 may include other mechanisms for communicating via a network, such as network 270.

Management layer 210 may perform processing associated with managing the overall operation of DEB 150, as described in detail below. Proxies 220 and 222 may perform processing associated with providing for secure transactions and transport delivery between various entities in network 200. According to an exemplary implementation, management layer 210 and proxies 220 and 222 may perform these operations in response to their respective processors 320 executing sequences of instructions contained in a computer-readable medium, such as their respective memories 330. A computer-readable medium may be defined as a physical or logical memory device and/or carrier wave.

The software instructions may be read into memory 330 from another computer-readable medium, such as data storage device 350, or from another device via communication interface 380. The software instructions contained in memory 330 may cause processor 320 to perform processes that will be described later. Alternatively, hard-wired circuitry may be used in place of or in combination with software instructions to implement processes consistent with the principles of the invention. Thus, implementations described herein are not limited to any specific combination of hardware circuitry and software.

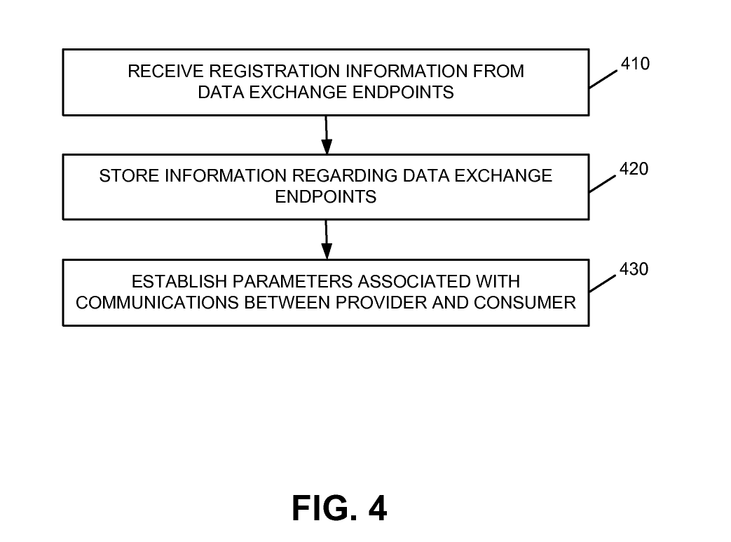

FIG. 4 is a flow diagram illustrating exemplary processing associated with establishing a data exchange service. Processing may begin when various entities, such as provider 250 and consumer 260, register with DEB 150 to subscribe to services provided by DEB 150. For example, provider 250 and consumer 260, referred to as data exchange endpoints, may be two entities that wish to exchange information, services, etc., with each other, as well as with other data exchange endpoints (e.g., other providers and consumers). Each of provider 250 and consumer 260 may forward registration information to DEB 150 via a secure proxy or portal (e.g., proxy 220 or 222). Management layer 210 may receive the registration information from provider 250 and consumer 260 (act 410).

For example, as described previously, provider 250 registration may include enrolling as a network-based data exchange infrastructure customer. During the enrolling process, provider 250 may provide information specifying the data or type of data to be exchanged and DEB 150 may publish this information within the context of an SLA. In this case, management layer 210 may receive information from provider 250 that identifies the entity (e.g., name, type of business, type of information desired to be provided/exchanged, etc.). Management layer 210 may also receive information that includes SLA information and/or an expected QoS associated with communications to/from another data exchange endpoint. Management layer 210 may further receive information identifying particular protocols/standards executed by provider 250. In some instances, the particular protocols/standards executed by provider 250 and consumer 260 may be different. Management layer 210 may also receive information from provider 250 that identifies a level of security for communications between provider 250 and other entities, such as what type of encryption to use, what type of message validation to use, etc. In some implementations, management layer 210 may receive information from provider 250 that identifies particular consumers with whom provider 250 wishes to communication.

Registration of consumer 260 with DEB 150, as described previously, may include enrolling as a network-based data exchange infrastructure customer. In this case, management layer 210 may receive information from consumer 260 identifying particular data or type of data desired to be exchanged with various providers. Management layer 210 may also receive information from consumer 260 that identifies particular providers with whom consumer 260 wishes to communication.

Management layer 210 may forward some or all of the received information from provider 250 and consumer 260 to provisioning system 230 for storage in database 232 or management layer 210 may store all or some of this information directly in database 232 (act 420).

Management layer 210 may then define a set of parameters and/or features for data exchange between endpoints in network 200 (e.g., provider 250 and consumer 260) based on the received registration information (act 430). In an exemplary implementation, DEB 150 may model the parameters/features for data exchange using a data exchange model within a network-based data exchange infrastructure. In an exemplary data exchange model, the endpoints (e.g., provider 250 and consumer 260) differ only in their relationships with those entities that represent the data to be exchanged and the business policies that govern the use of the data, as described in detail below.

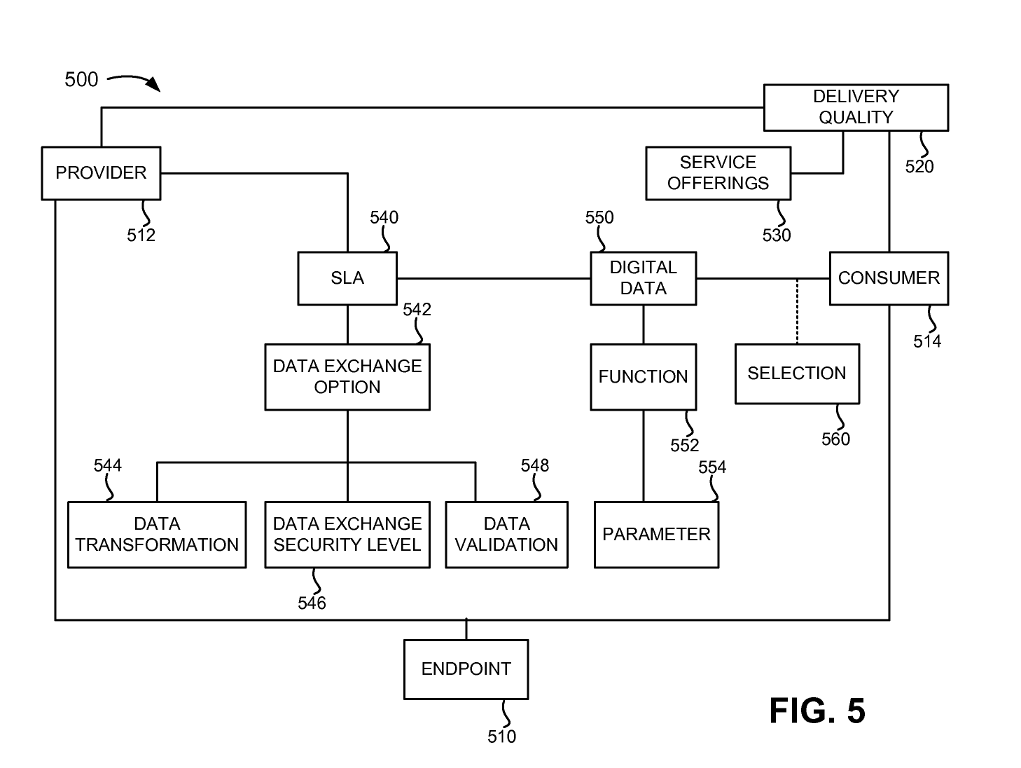

FIG. 5 illustrates an exemplary network-based data exchange model 500 for use within a network-based data exchange infrastructure, such as network 200. In an exemplary implementation, DEB 150 may perform processing associated with the exchange of data in accordance with data exchange model 500. Data exchange model 500 may represent various entities in the network-based data exchange infrastructure as Endpoint objects, Delivery Quality objects, Service Offerings objects, Service Level Agreement (SLA) objects, Data Exchange Option objects, Digital Data objects and other objects, as described in detail below.

For example, referring to FIG. 5, data exchange model 500 may include Endpoint object 510, Provider object 512 and Consumer object 514. Data exchange model 500 may represent Provider and Consumer objects 512 and 514 as instances (or subtypes) of Endpoint object 510. Provider 250 and consumer 260 (FIG. 2) may correspond to Provider and Consumer objects 512 and 514, respectively. Each Endpoint object 510 may be defined to include a set of basic features. These basic features may include a unique identifier, such as an account number and endpoint ID combination; secure system access elements, such as a password and a certificate (e.g., a digital certificate); a status which indicates the validity of the account; and an endpoint address which may represent the physical address of the endpoint in the network or the logical address of the endpoint in the network-based data exchange infrastructure.

Data exchange model 500 may also include Delivery Quality object 520 that represents those delivery functions that are performed during a data exchange between endpoint objects 510 (e.g., Provider object 512 and Consumer object 514). Data exchange model 500 may further include Service Offerings object 530 that includes a set of delivery functions that a consumer (e.g., consumer 260) may use and a provider (e.g., provider 250) may supply in order for a data exchange to occur. In an exemplary implementation, each instance of the Delivery Quality object 520 may determine the set of delivery functions associated with Service Offerings object 530 and determine whether to grant a consumer access to particular data.

Provider object 512 may be associated with Delivery Quality object 520 and may have one or more SLA objects 540. SLA object 540 may represent the performance obligation that DEB 150 will provide to the data exchange endpoint entities (e.g., provider 250 and consumer 260). In one implementation, Delivery Quality object 520 guarantees compliance with the provider's data exchange requirements as defined by one or more data exchange option objects, represented by Data Exchange Option object 542. Delivery Quality object 520 may also define penalties for non-compliance with various guarantees, such as SLA-related guarantees.

Data Exchange Option object 542 may be included, excluded or considered an optional member of an SLA (e.g., SLA object 540). In an exemplary implementation, a set of Data Exchange Option objects 542 associated with a specific SLA instance define data transformations needed for endpoints to communicate, data exchange security level for system access and data validation features for a data exchange. These transformations, security related access and data validation features are represented by Data Transformation object 544, Data Exchange Security Level object 546 and Data Validation object 548.

SLA object 540 also describes or defines the data exchange structure by an associated set of Digital Data object hierarchies, represented by Digital Data object 550. Function object 552 may define a particular function associated with Digital Data object 550. Parameter object 554 may define one or more parameters associated with Function object 554. This set of Digital Data object hierarchies (e.g., objects 550, 552 and 554) defines the means by which a consumer may participate in a digital data exchange with a provider.

Digital Data object 550 may also be subject to various restrictions by Selection object 560, as indicated by the dotted line in data exchange model 500. For example, a provider may refuse to exchange data with particular consumers, or vice versa. Such restrictions may be defined by Selection object 560.

As discussed above with respect to FIG. 4, data exchange model 500 may require that both provider and consumer data exchange endpoints register with the DEB 150 prior to exchanging data. Assume that both provider 250 and consumer 260 (FIG. 2) have registered with DEB 150. DEB 150 may then facilitate data exchange between providers and consumers, as described in detail below.

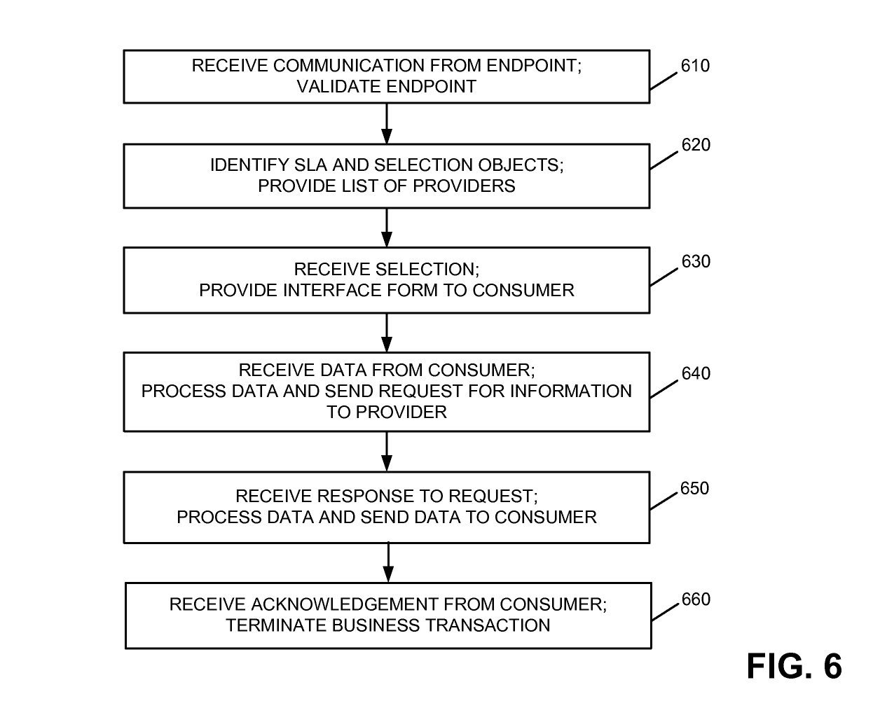

FIG. 6 illustrates exemplary processing associated with communications in network 200. Processing may begin when a consumer, such as consumer 260 establishes communications with DEB 150. DEB 150 may receive the communication from consumer 260 and determine whether consumer 260 is a valid customer (act 610). For example, management layer 210 may receive the communication from consumer 260 via proxy 222 and determine whether consumer 260 has registered with DEB 150, as described above with respect to FIG. 4. In this case, assume that consumer 260 is a valid customer. DEB 150 may then authenticate or validate consumer 260 (act 610).

Management layer 210 may then access provisioning system 230 and/or database 232 to identify, for example, an SLA object 540 and Selection object 560 associated with consumer 260 (act 620). The combination of SLA and Selection objects 540 and 560 defines the business relationship between a consumer and one or more particular providers and an expected delivery quality (e.g., Delivery Quality object 520) associated with the business relationship. In addition, as discussed above, Selection object 560 may provide restrictions on which providers are set up to exchange information with consumer 260. For example, one or more providers may not wish to exchange data with consumer 260 and/or consumer 260 may not wish to receive information from one or providers. Based on the relationships defined by SLA object 540 and Selection object 560, management layer 210 may generate a list of providers with whom consumer 260 may communicate. That is, management layer 210 may access database 232 and identify a list of providers that meet the SLA and Selection objects 540 and 560 associated with consumer 260. Management layer 210 may forward the list to consumer 260 (act 620).

From this list, assume that consumer 260 selects a provider with whom to exchange digital data, such as provider 250. DEB 150 receives the selection via, for example, proxy 222 (act 630). Management layer 210 may then provide a dynamic, user-friendly order form/interface, such as a graphical user interface (GUI) compatible with consumer 260, which allows consumer 260 to easily input information regarding a digital data exchange. In an exemplary implementation, the information input by consumer 260 may correspond to Digital Data object 550 hierarchies that define the format of the digital data exchange (e.g., what type of information is being requested), the Delivery Quality object 520 that defines how the business transaction is to be conducted, etc. For example, management layer 210 may provide a dynamic GUI that includes a number of business transaction parameter and attachment fields for consumer 260 to populate. These fields may be based on the type of data exchange transaction that is to be conducted and may be based on information provided by consumer 260 while registering with DEB 150. For example, during the registering with DEB 150, consumer 260 may have indicated that he/she would like to exchange digital data regarding consumer products (e.g., electronic products, music players, household appliances, etc.). DEB 150 may have stored this information in provisioning system 230 and/or database 232. In this case, the GUI may include a product field, a type field, a price field, a size field, a quantity field, etc. Consumer 260 may populate these fields based on his/her particular request.

As an example, suppose that consumer 260 wishes to receive information regarding television sets. In this case, consumer 260 may input the term “television” into the product field, input the term “plasma,” “liquid crystal display (LCD),” etc., into the type field, a maximum dollar amount into the price field, input a number into the size field and input a number into the quantity field. Consumer 260 may forward this information to DEB 150.

DEB 150 receives the information input via the GUI regarding television sets (e.g., a set of Digital Data object hierarchies) via, for example, proxy 222 (act 640). Management layer 210 may then process the data (act 640). For example, management layer 210 may perform security-related processing, such as encryption, associated with the received data. Management layer 210 may also perform data validation on the received data to ensure that the data came from a registered subscriber to services of DEB 150. Management layer 210 may determine whether to transform the requested information into a user-friendly format compatible with provider 250. For example, management layer 210 may generate a user-friendly GUI based on the information provided by consumer 260 which enables provider 250 to easily input the desired information, as described in detail below.

Management layer 210 may then initiate a business transaction by establishing a connection to the data exchange endpoint associated with provider 250 and send the information to provider 250 in the form of a request for digital data (act 640). That is, management layer 210 may forward the requested information provided by consumer 260 via the populated fields of the GUI to provider 250. The information in the request, as described above, may have been transformed, if necessary, into a user-friendly form (e.g., GUI) compatible with provider 250.

As discussed above, since management layer 210 performed security-related and validation-related processing on the information/request, etc., prior to forwarding the request, provider 250 may be assured that the request is valid and from a consumer with whom provider 250 has agreed to exchange information. In addition, since management layer 210 performed any necessary transformation of the data request into a format compatible with provider 250, the request may also be in a form that is easy for provider 250 to understand and in a form which facilitates a response from provide 250.

For example, management layer 210 may forward a dynamic order form that identifies the sender (i.e., consumer 260 in this example) and the type of information that consumer 260 is requesting. In one implementation, the user-friendly order form (e.g., a GUI) may include business transaction parameter and attachment fields based on the information requested by consumer 260. Provider 250 may populate these fields based on his/her particular request.

For example, in the example discussed above with respect to television sets, the GUI may include fields that allow personnel associated with provider 250 to input information regarding various televisions that satisfy the request of consumer 260. In some instances, the information may be automatically provided via software at provider 250. That is, the GUI may be in a form that is compatible with systems/databases at provider 250 and that enables the systems/databases at provider 250 to be automatically searched, without human intervention, to provide a response to the request. In each case, provider 250 processes the request from DEB 150, identifies what data is requested and returns the requested data in a response to DEB 150 (act 650). In an exemplary implementation, the response from provider 250 may correspond to a specific set of Digital Data object 550 hierarchies that define the data.

DEB 150 receives the information from provider 250 and processes the data (act 650). For example, similar to the processing described above with respect to data received from consumer 260, management layer 210 may perform security-related processing, such as encryption, associated with the received data. Management layer 210 may also perform data validation on the received data to ensure that the data came from a registered subscriber to services of DEB 150. In an exemplary implementation, management layer 210 may determine whether to perform any transformations of the received data based on information stored in database 232. For example, management layer 210 may transform or modify the requested information into a user-friendly format compatible with consumer 260. Management layer 210 may then forward the data to consumer 260 (act 650).

Consumer 260 may receive the data from management layer 210 (act 660). In the example above, the data may include information identifying a number of television sets, prices, availability, etc., that meet the request for information from consumer 260. Consumer 260 may acknowledge receipt of the information by forwarding an acknowledgement to DEB 150 (act 660). DEB 150 may receive the acknowledgement and terminate the business transaction by acknowledging the receipt of the response to provider 250 (act 660). DEB 150 may also close the connection to each of the data exchange endpoints associated with provider 250 and consumer 260.

The methodology described above with respect to FIG. 6 may be used in a variety of applications in which entities, such as providers and consumers exchange information. In the example provided above, consumer 260 and provider 250 exchanged commercial information regarding consumer goods.

In other implementations, consumer 260 and provider 250 may exchange other types of information, such as medical information, financial information, etc. For example, in another implementation, provider 250 may be a medical doctor and consumer 260 may be a hospital treating one of the doctor's patients. In this example, consumer 260 may wish to receive a patient's medical history/records or a portion of the patient's medical history. In this case, DEB 150 may provide a GUI that includes fields for inputting a period of time for which the records are requested, fields for inputting the type of information requested (e.g., heart-related medical information, medications which the patient is taking, etc.). This information may then be provided to DEB 150. Management layer 210 may process the information as described above, (e.g., perform security-related processing, message validation processing, transformation-related/compatibility-related processing, etc.) and forward the request to provider 250 (i.e., the doctor in this example). Provider 250 may then provide the desired information to DEB 150. DEB 150 may then process the received information as described above, (i.e., perform security-related processing, message validation processing, transformation-related/compatibility-related processing, etc.) and provide the information to consumer 260 (i.e., the hospital in this example) in a format compatible with consumer 260.

In an exemplary implementation, services of DEB 150 may be available to entities, such as providers and consumers through a Web portal. A Web portal may be a single point of access to information which is linked to various logically related Internet-based applications and which may be of interest to various types of users. In some implementations, a Web portal may present information from diverse sources in a unified way by providing a consistent look and feel associated with access control and procedures for multiple applications.

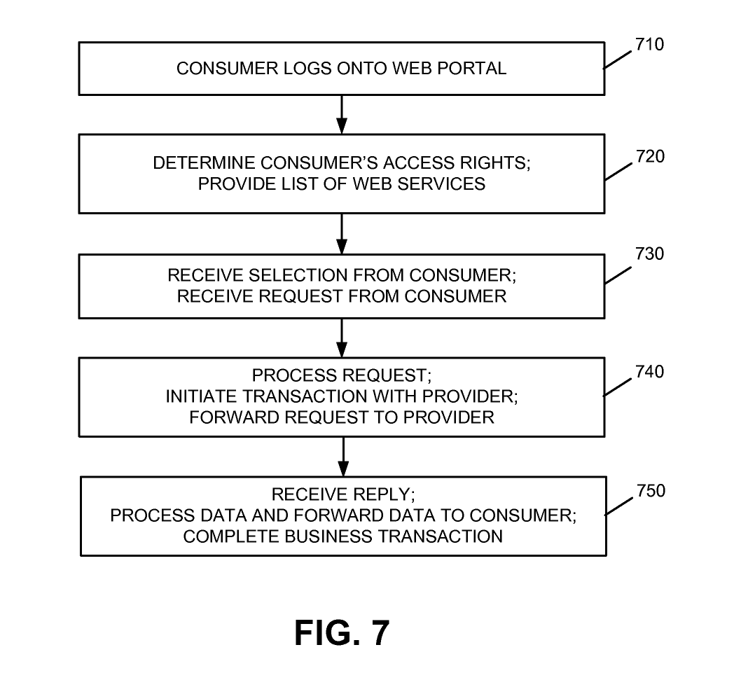

FIG. 7 illustrates exemplary processing associated with use of DEB 150 in conjunction with a Web portal application. Processing may begin by consumer 260 logging onto a Web portal interface associated with DEB 150 (act 710). DEB 150 may receive the login information and determine consumer 260's access rights to identify which Web services may be selected (act 720). Based on the access rights of consumer 260, DEB 150 may provide a list of available Web services to consumer 260 via a user-friendly graphical user interface (GUI) (act 720).

Assume that consumer 260 selects (e.g., clicks on) a particular one of the listed Web services. DEB 150 may receive the selection (act 730). DEB 150 may then provide a user-friendly GUI with one or more fields for consumer 260 to populate. These fields may be based on the particular consumer 260 and may define the data exchange with one or more providers, such as provider 250. Consumer 260 may populate these fields and send the data/request to DEB 150 (act 730).

DEB 150 may receive the request and process the request (act 740). For example, DEB 150 may perform security-related processing, validation-related processing, compatibility-related processing, etc., on the request to ensure the validity of the request and that the request will be in a format compatible with the provider. DEB 150 may then initiate a business transaction with a data exchange endpoint entity associated with the selected Web service (act 740). For example, assume that provider 250 is associated with the selected Web service. DEB 150 may create and send a SOAP message request to provider 250. The SOAP message may include information associated with the request, such as an identification of consumer 260, type of information requested, etc. Provider 250 may then provide data in response to the message/request.

DEB 150 may receive the data from provider 250 and perform various processing (e.g., security-related processing, validation-related processing, compatibility related processing, etc.) to ensure that the data is secure and is in a format compatible with consumer 260 (act 750). DEB 150 may then forward the data to consumer 260 (act 750).

Consumer 260 may receive the data and send an acknowledgment reply to DEB 150. For example, consumer 260 may send a SOAP acknowledgment reply to the Web portal. DEB 150 may receive the acknowledgment reply and complete the business transaction (act 750). In this manner, DEB 150 may facilitate the creation of a consumer Web service on the fly using a dynamic definition of information exchange which may be stored in a database, such as database 232.

As discussed above, DEB 150 may ensure that communications to/from endpoints in network 200 are in a form that enables the receiving endpoint to easily use or respond to the communication. In some implementations, provisioning system 230 and/or management layer 210 may determine that proxies 220 and 222 may need to modify a particular message received by provider 250 and/or consumer 260, such as perform an extensible stylesheet language (XSL) transformation, so that the message will be compatible or usable by provider 250 and/or consumer 260. Provisioning system 230 may also identify security related requirements to be performed by DEB 150. That is, as discussed above, DEB 150 may perform security related processing, such as encryption, decryption, providing digital signatures, etc. The particular level or depth of these services, such as the particular level of encryption, may be based on the agreed upon SLA between provider 250 and consumer 260. In each case, provisioning system 230 may store provisioning related information in database 232 to facilitate communications between provider 250 and consumer 260.

As also discussed above, DEB 150 may store information regarding communications between provider 250 and consumer 260 and/or forward information regarding communications between provider 250 and consumer 260 to backend systems 240. For example, management layer 210 may receive transaction information from proxies 220 and 222. This transaction information may include, for example, a transaction identifier (ID), information identifying the origination and destination parties associated with the message, the size of the message, time stamp information, an identifier of a network element involved in the transaction (e.g., one of proxies 220 or 222), etc. Management layer 210 may store all or a portion of this transaction information in various ones of backend systems 240 for processing by the respective backend systems. Alternatively, management layer 210 may store this transaction information locally, such as on storage device 350 (FIG. 3), for access by backend systems 240.

As one example, a billing system included in backend systems 240 may use the stored transaction information for billing entities (e.g., one or both of provider 250 and consumer 260) in network 200 in an accurate manner based on the particular agreed upon parameters. That is, the billing system may allow for detailed billing of each transaction, each communication session, etc., based on the agreed upon parameters. In exemplary implementations, the billing may be based on the size/amount of data exchanged between entities. Alternatively, the billing may be based on a set fee per transaction, a fixed monthly fee regardless of the number of transactions, a monthly fee based on a number of transactions (e.g., a first fixed fee for X transactions, a second fixed fee for up to Y transactions, where Y is greater than X; various fixed fees depending on the number of transactions, etc.), or any combination of these fee arrangements agreed upon by the entities registered with DEB 150.

As another example, a monitoring system included in backend systems 240 may use the stored transaction information to determine whether communications between entities in network 200 meet QoS requirements, SLAs requirements, penalties for not meeting QoS/SLA requirements, etc. In each case, backend systems 240 may use stored transaction information for billing one or both of provider 250 and consumer 260 for the particular transaction/communication session, for auditing purposes, for monitoring purposes, etc.

In addition, backend systems 240 may operate in a transparent manner with respect to provider 250 and consumer 260. That is, provider 250 and consumer 260 may exchange information, services, etc., and backend systems 240 may perform monitoring and/or billing without requiring provider 250 or consumer 260 to track the exchange of information.

As described above, management layer 210 may perform security and validation related processing. In other implementations, some or all of these functions may be performed by proxies, such as proxies 220 and 222. For example, proxy 220 and/or 222 may perform message encryption, decryption, generate a digital signature for forwarding with a message, perform message validation, perform data compression or de-compression on a message, transform the message into a format compatible with a provider and/or consumer, etc. Intermediate proxies may also be included in network 200. In an exemplary implementation, each proxy that receives message data may forward transaction information, such as the transaction information described above (i.e., a transaction ID, information identifying the origination and destination parties associated with the message, the size of the message, time stamp information, an identifier of a network element involved in the transaction), to management layer 210. Management layer 210 may then store and/or forward this transaction information to backend systems 240. In this manner, the transmission of message data between subscribers (e.g., consumer 260 and provider 250) may be traced back at a later time for various purposes.

As described above, DEB 150 acts as a broker and/or manager to manage data exchange between endpoints. In addition, when changes are made to various equipment and/or procedures associated with one or both of provider 250 and consumer 260, provider 250 and/or consumer 260 may notify DEB 150 of the changes and DEB 150 may perform various processing needed to ensure that the changes are reflected at DEB 150. For example, DEB 150 may store the changes in database 232 and immediately implement the changes via data exchange model 500. This enables DEB 150 to provide on-going support and change management to ensure that endpoint entities (e.g., provider 250 and consumer 260) are able to communicate with each other in accordance with agreed upon parameters.

Implementations described herein provide a data exchange infrastructure to facilitate the exchange of data and communications between various entities. By transferring various processing associated with the data exchange, both providers and consumers may simplify their processing associated with obtaining information, providing information and/or exchanging information with other entities. For example, compatibility related processing, security related processing, accounting related processing, auditing related processing and monitoring related processing may be performed by DEB 150, thereby simplifying processing performed by the entities exchanging the data.

Implementations described herein may also be used in connection with exchanging any type of information. For example, commercial information, medical information, financial information, business information, news information, general information of interest, etc., may be transferred in various implementations in connection with the processing described above. Further, any entity/company that uses a Web services paradigm for providing access to information, an electronic data exchange (EDI) structure for structuring transactions and exchanging information or any other paradigm/structure/system for exchanging information may subscribe to services provided by DEB 150 to facilitate the exchange of information. Still further, any entity/company that participates in peer-to-peer (P2P), business-to-business (B2B) and exchange-to-exchange (E2E) type applications may subscribe to services provided by DEB 150 to facilitate the exchange of information.

The foregoing description of exemplary implementations provides illustration and description, but is not intended to be exhaustive or to limit the invention to the precise form disclosed. Modifications and variations are possible in light of the above teachings or may be acquired from practice of the invention. For example, various features have been described above with respect to components in DEB 150. In some implementations, the functions performed by some of these components may be performed by other components. In other implementations, the functions described as being performed by multiple components may be performed by a single component.

In addition, while the transaction described above focused on a single provider and a single consumer, it should be understood that a large number of providers and consumers may interact via DEB 150. Further, a data exchange involving a single request from one entity (i.e., consumer 260) to another entity (i.e., provider 250) and the reply that includes the desired information has been described above. It should be understood that a typical data exchange or communication session associated with a request for service, information, etc., may involve multiple communications between the entities. In each case, DEB 150 may perform processing to facilitate the multiple communications and also store transaction information associated with each communication.

In addition, while series of acts have been described with respect to FIGS. 4, 6 and 7, the order of the acts may be varied in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting of the invention. Thus, the operation and behavior of the aspects of the invention were described without reference to the specific software code—it being understood that one would be able to design software and control hardware to implement the various features based on the description herein.

Further, certain portions of the invention may be implemented as “logic” that performs one or more functions. This logic may include hardware, such as a processor, a microprocessor, an application specific integrated circuit, or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A system, comprising:
a data exchange platform configured to facilitate communications between a first entity and a second entity, the data exchange platform comprising:
a memory configured to store information regarding the first and second entities, and
logic configured to:
receive a communication from the first entity,
identify, based on the communication and the information stored in the memory, at least the second entity,
receive first information from the first entity defining parameters associated with a data exchange between the first and second entities,
forward a request to the second entity, the request being based on the first information,
receive, from the second entity and in response to the request, data for the data exchange, and
forward the data to the first entity.

2. The system of claim 1, wherein the logic is further configured to:
provide, to the first entity, a user interface including a plurality of fields for entering the first information, and
transform at least a portion of the first information into a message comprising a transaction parameter field.

3. The system of claim 2, wherein when forwarding a request, the logic is further configured to:
forward the message comprising the transaction parameter field with the request.

4. The system of claim 1, wherein the logic is further configured to:
perform at least one of security-related processing and validation-related processing on the first information,
identify, based on information stored in the memory, a format associated with the second entity, and
transform the first information into the format associated with the second entity prior to forwarding the request.

5. The system of claim 1, wherein the logic is further configured to:
perform at least one of security-related processing and validation-related processing on the data received from the second entity,
identify, based on information stored in the memory, a format associated with the first entity, and
transform the data received from the second entity into the format associated with the first entity prior to forwarding the data to the first entity.

6. The system of claim 1, wherein the memory is further configured to store policy information associated with data exchange between a plurality of entities.

7. The system of claim 1, wherein the data exchange platform comprises a portal accessible via the Internet.

8. The system of claim 1, wherein when identifying at least the second entity, the logic is configured to:
identify a plurality of entities with whom the first entity is able to communicate, the logic being further configured to:
provide information identifying the plurality of entities to the first entity.

9. The system of claim 1, wherein the logic is further configured to:
receive identification information associated with the first and second entities, and store information in the memory identifying the first and second entities as subscribers to the system.

10. The system of claim 1, wherein the logic is further configured to:
identify requirements associated with communications between the first and second entities,
forward the request to the second entity based on at least some of the identified requirements, and
forward the data to the first entity based on at least some of the identified requirements.

11. The system of claim 1, wherein the data exchange platform further comprises:
at least one component configured to:
receive transaction information associated with a communication between the first and second entities, and
perform at least one of billing related processing, auditing related processing, or monitoring related processing based on the transaction information.

12. The system of claim 1, further comprising:
a first proxy configured to:
perform security related processing for communications between the first and second entities, the security related processing comprising at least one of encryption or message validation, and
forward the processed communication to at least one of the first entity or second entity.

13. A method comprising:
storing information in a memory, the information identifying a plurality of entities and data exchange information associated with exchanging information between the plurality of entities;
receiving a request for information from a first one of the plurality of entities;
identifying, based on the request and information stored in the memory, at least a second one of the plurality of entities;
receiving first information from the first entity, the first information defining data or a type of data to be provided by the second entity;
modifying the request to a format compatible with the second entity based on information stored in the memory;
forwarding the modified request to the second entity;
receiving, from the second entity and in response to the modified request, data for the first entity;
modifying the data received from the second entity based on information stored in the memory; and
forwarding the modified data to the first entity.

14. The method of claim 13, further comprising:
receiving registration information associated with the first and second entities, the registration information defining at least a service level agreement (SLA) associated with communications between the first and second entities; and
storing the SLA associated with communications between the first and second entities in the memory.

15. The method of claim 13, further comprising:
providing a user interface to the first entity, the user interface comprising a plurality of fields for inputting the first information, and wherein the modifying the request comprises:
providing data exchange parameter information in the modified request.

16. The method of claim 13, further comprising:
accessing the memory to identify the format compatible with the second entity prior to modifying the request.

17. The method of claim 13, wherein the request for information is received by a portal accessed via the Internet.

18. The method of claim 13, wherein the identifying at least a second one of the entities comprises:
identifying a plurality of entities with whom the first entity is able to communicate, the plurality of entities being restricted based on information stored in the memory, the method further comprising:
providing information identifying the plurality of entities to the first entity.

19. The method of claim 13, further comprising:
receiving transaction information associated with at least one data exchange between the first and second entities; and
performing at least one of billing related processing, auditing related processing, or monitoring related processing based on the transaction information.

20. The method of claim 19, further comprising:
identifying an amount of data associated with a data exchange or a communication session between the first and second entities;
identifying billing parameters agreed to by the first and second entities; and
generate billing information based on the amount of data and the billing parameters.

21. A system, comprising:
means for receiving a communication from a first entity intended for a second entity;
means for identifying a plurality of entities;
means for receiving a selection from the first entity corresponding to the second entity;
means for providing a user interface to the first entity;
means for receiving first information from the first entity via the user interface, the first information defining data or a type of data to be provided by the second entity;
means for modifying the request into a format compatible with the second entity;
means for forwarding the modified request to the second entity;
means for receiving, from the second entity and in response to the modified request, data intended for the first entity;
means for modifying the data received from the second entity into a format compatible with the first entity; and
means for forwarding the modified data to the first entity.

22. The system of claim 21, further comprising:
means for billing at least one of the first entity or the second entity based on the data from the second entity.
